(19) United States
(12) Patent Application Publication
(10) Pub. No.: US 2018/0056362 A1
(43) Pub. Date: Mar. 1, 2018

(54) METHOD OF PRODUCING A PLATE HEAT EXCHANGER

(71) Applicant: Alfa Laval Corporate AB, Lund (SE)

(72) Inventor: Per SJÖDIN, Lund (SE)

(73) Assignee: Alfa Laval Corporate AB, Lund (SE)

(21) Appl. No.: 15/562,191

(22) PCT Filed: Mar. 11, 2016
(86) PCT No.: PCT/EP2016/055296

§ 371 Date: Sep. 27, 2017

(30) Foreign Application Priority Data
Apr. 7, 2015 (EP) 15162693.4
Dec. 11, 2015 (EP) 15199686.5

(51) Int. Cl. B21D 53/04; F28D 9/00; B23P 15/26

(52) U.S. Cl. CPC B21D 53/04; B23P 15/26; F28D 9/0093

(57) ABSTRACT

A method of producing a heat exchanger, comprising: obtaining a titanium plate that has been cladded with a melting depressant foil, and heat treated; pressing a pattern in the titanium plate; stacking the titanium plate on a number of similar titanium plates; heating the stack of titanium plates to a temperature above 850° C. and below the melting point of titanium, the melting depressant foil causing surface layers of the titanium plates to melt and flow to contact points between adjacent titanium plates; and allowing the melted titanium to solidify, such that joints are obtained at the contact points between adjacent titanium plates.

### TECHNICAL FIELD

The invention relates to a method of producing a plate heat exchanger with plates that are made of titanium. The invention also relates to a titanium plate heat exchanger and to a metal coil that is used for producing the titanium plate heat exchanger.

### BACKGROUND ART

Today plate heat exchangers with permanently joined titanium plates are often manufactured by brazing the plates to each other. This is done by applying a brazing material on the plates and by heating the plates such that the brazing material melts and forms joints between the plates. The brazing material includes a so called filler metal, and it is this metal that forms the joints that joins the titanium plates. As for all brazing techniques of this type, the brazing material includes a melting depressant composition that causes the filler metal to melt at a temperature that is lower than the melting temperature of the titanium plates that are joined to each other.

A number of techniques exist for joining titanium plates into a plate heat exchanger. U.S. Pat. No. 7,201,973 describes one such technique, where the brazing material includes an amount of 30 to 50 wt % titanium (Ti), 15 to 25 wt % zirconium (Zr), 15 to 25 wt % copper (Cu) and 15 to 25 wt % nickel (Ni). More specifically, the used brazing material includes 40 wt % Ti, 20 wt % Zr, 20 wt % Cu and 20 wt % Ni. The titanium is the filler metal while the other metals act as melting depressant components for the titanium.

The filler metal and the melting depressant components typically have the form of metal powders. To bind the metal powder, the brazing material typically also includes a binder composition that gives the brazing material the form of a paste or a liquid that may be sprayed, painted or in another suitable way applied on the titanium plates. It is important that the brazing material is properly applied on the titanium plates, in the correct amounts and on the correct places.

Applying the brazing composition is an operation that involves both costs and a risk of introducing errors and faults in the process of manufacturing heat exchangers. Thus, there is a need for improving the process of manufacturing a plate heat exchanger, in particular those made of titanium, which typically rely on very traditional brazing techniques.

### SUMMARY

It is an object of the invention to provide an improved method for manufacturing a plate heat exchanger that is made of titanium plates. In particular, an object is to reduce or even eliminate the need of using a binder composition for applying a brazing composition on titanium heat transfer plates.

Thus, a method for producing a plate heat exchanger is provided. The method comprises: obtaining a titanium plate that has been cladded with a melting depressant foil on at least one side of the plate, and, optionally, heat treated after the cladding for improving its ductile properties; pressing a pattern in the titanium plate, such that tops and bottoms are formed in the plate; stacking the titanium plate on a number of similar titanium plates, so as to form a stack of clad and pressed titanium plates, where contact points are formed between adjacent titanium plates in the stack of titanium plates; heating the stack of titanium plates to a temperature above 850° C. and below the melting point of titanium, such that the melting depressant foil acts as a melting depressant for the titanium in the titanium plates and causes surface layers of the titanium plates to melt, the melted titanium thereby flowing to the contact points between adjacent titanium plates; and allowing the melted titanium to solidify, such that joints are obtained at the contact points between adjacent titanium plates.

The method is advantageous in that no binder composition must be used for accomplishing the joints, and in that no material, such as a brazing material, must be applied on the plates after they have been pressed. In the described method the step of stacking the titanium plate on a number of similar titanium plates is performed. In this context, “similar” refers to plates that are clad with the same melting depressant foil and which also have a base of titanium. The plates are then similar or even identical as seen from a production perspective, i.e. the step of “obtaining” is the same for all “similar” plates. The pattern in “similar” plates may differ.

Other objectives, features, aspects and advantages of the production method will appear from the following detailed description as well as from the drawings. A titanium plate heat exchanger that is manufactured according to the method herein as well as a metal coil that is suitable for use with the method is also described, and provides corresponding advantages.

### BRIEF DESCRIPTION OF THE DRAWINGS

Embodiments of the invention will now be described, by way of example, with reference to the accompanying schematic drawings, in which

FIG. 1 is a side view of a titanium plate heat exchanger,

FIG. 2 is a front view of the titanium plate heat exchanger of FIG. 1,

FIG. 3 is a front view of a pressed and cut titanium heat transfer plate that is part of the plate heat exchanger of FIG. 1,

FIG. 4 is a front view of the titanium heat transfer plate of FIG. 3, before it has been pressed and cut,

FIG. 5 illustrates a cross-section of the titanium plate of FIG. 3, clad with a melting depressant foil,

FIG. 6 illustrates how a titanium plate is clad with a melting depressant foil,

FIG. 7 is an enlarged, partial view of two titanium heat transfer plates at a contact point, before they are joined,

FIG. 8 is an enlarged, partial view of the two heat transfer plates in FIG. 7, after they have been joined,

FIG. 9 illustrates a coil that is made of a titanium plate that has been clad with a melting depressant foil, and

FIG. 10 is a flow schedule that illustrates a method of producing a titanium plate heat exchanger like the one in FIG. 1,

### DETAILED DESCRIPTION

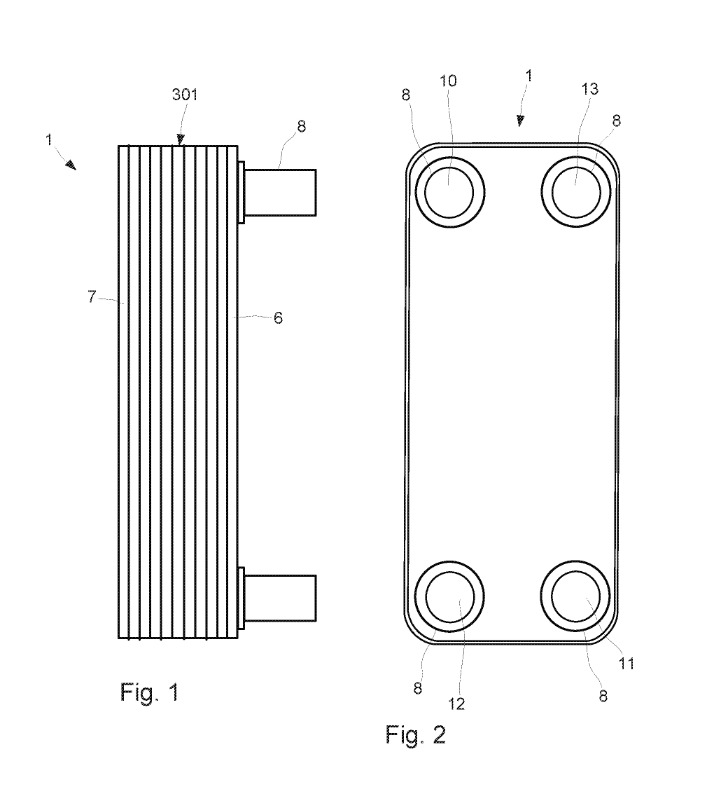

With reference to FIGS. 1 and 2 a plate heat exchanger 1 is illustrated. The plate heat exchanger 1 is primarily made of titanium and is thus referred to as a “titanium plate heat exchanger”. The plate heat exchanger 1 comprises a stack 301 of heat transfer plates, and a first end plate 6 that is arranged on a first side of the stack 301 and a second end plate 7 that is arranged on a second side of the stack 301. The end plates 6, 7 have the same shape and form as the heat transfer plates in the stack 301, but are slightly thicker for providing protection against external forces.

The stack 301 of heat transfer plates are permanently joined to each other to form the plate stack 301 and has alternating first and second flow paths for a first fluid and a second fluid that flow in between the heat transfer plates. The plate heat exchanger 1 has a first fluid inlet 10 and a first fluid outlet 11. The first fluid inlet 10 receives the first fluid and leads the first fluid to the first flow path between the heat transfer plates in the plate stack 301. The first fluid outlet 11 receives the first fluid from the first flow path and allows the fluid to exit the plate heat exchanger 1. The plate heat exchanger 1 has a second fluid inlet 12 and a second fluid outlet 13. The second fluid inlet 12 receives the second fluid and leads the second fluid to the second flow path between the heat transfer plates. The second fluid outlet 13 receives the second fluid from the second flow path and allows the second fluid to exit the plate heat exchanger 1.

Connectors 8 are arranged around each of the inlets and the outlets, and each connector 8 has the form a pipe. Fluid lines for the two fluids may then be connected to the plate heat exchanger 1 via the connectors 8. Any suitable technique may be used for accomplishing such connection, and the connectors 8 are typically made of the same material as the heat transfer plates in the stack 301. Inlets and outlets for one of the fluids me be reversed, such that there is a co-current flow of the fluids, instead of a counter flow as illustrated.

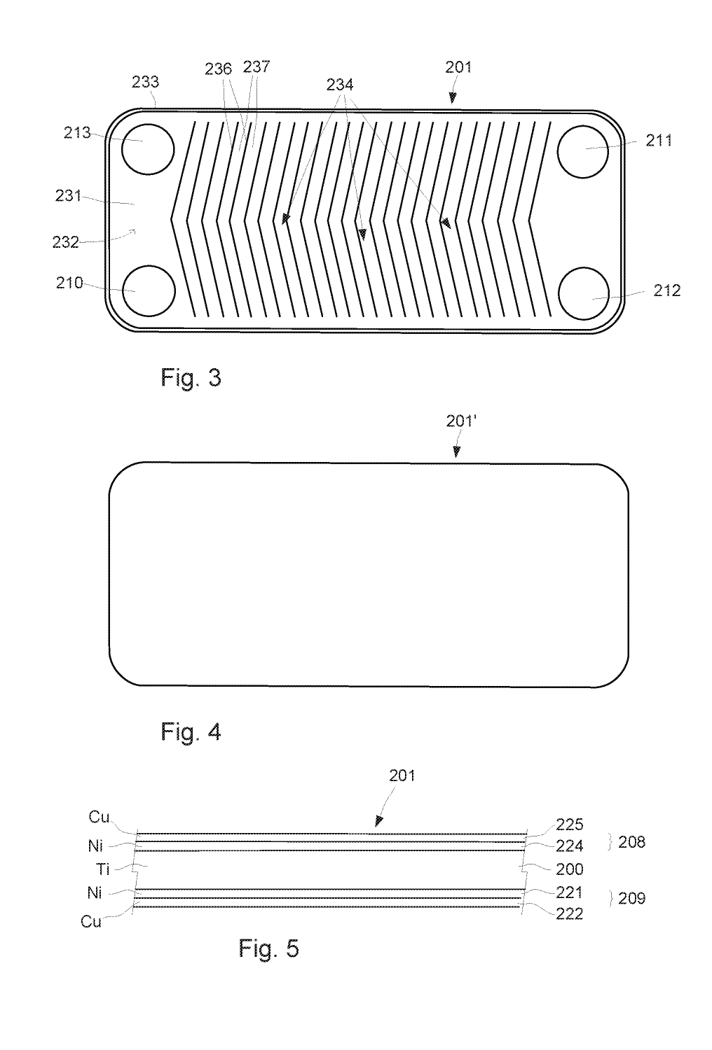

With reference to FIG. 3 a heat transfer plate 201 that is used for the plate heat exchanger 1 is illustrated. All heat transfer plates in the stack 301 may be identical to the heat transfer plate 201 of FIG. 3, apart from the end plates 6, 7 which are thicker. The heat transfer plates are arranged on top of each other, with every second heat transfer plate turned 180° around a normal direction of a plane that is parallel to the heat transfer plate. It is also possible to use two different heat transfer plates, where the different heat transfer plates are stacked alternatively on each other. The heat transfer plate 201 has four through holes 210-213, also referred to as port openings, which are aligned with the inlets and outlets 10-13 of the plate heat exchanger 1, A pattern 234 in form of alternating tops 236 and bottoms 237 is pressed into the heat transfer plate 201. The heat transfer plate 201 has a first side 231 and a second side 232 that is opposite the first side 231. A peripheral edge 233 extends around the heat transfer plate 201 and is folded from the first side 231 towards the second side 232. The edge 233 abuts an underlying heat transfer plate and provides a seal to the periphery to the underlying heat transfer plate.

The forms and shapes of the plate heat exchanger 1, the fluid paths for the fluids, the heat transfer plates 201 and the connectors 8 are per se known within the art and can be accomplished according to known techniques. However, the plate heat exchanger 1 is produced in a new manner, by using a plate material with special properties that effectively joins the heat transfer plates in the stack 301. Before the pattern 234 is pressed and the through holes 210-213 and the edge 233 of the heat transfer plate 201 have been formed, the heat transfer plate 201 has the form of a flat heat transfer plate 201′ as illustrated by FIG. 4. The heat transfer plate 201 is mainly made of titanium, and is thus referred to as a “titanium plate”. Reference numeral 201′ indicates the same plate as the plate with reference numeral 201, but before it is pressed and cut.

With reference to FIG. 5 a cross-section of heat transfer plate 201, 201 is illustrated as it appears before it has been joined with adjacent heat transfer plates. The heat transfer plate 201 has a core in form of a titanium plate 200. A first melting depressant foil 208 is arranged on the first side 231 of the titanium plate 200. The first melting depressant foil 208 comprises a nickel (Ni) foil 224 and a copper (Cu) foil 225. Instead of the copper foil 225 a zirconium (Zr) foil may be used. The nickel foil 224 is arranged closest to the titanium plate 200. The titanium plate 200 has a thickness of 0.25 to 1.5 mm and may be made of e.g. titanium type grade 1 or titanium type grade 2. The titanium plate 200 may have a greater thickness, such 1.5 to 5.0 mm, before a melting depressant foil is cladded on the plate 200. Cladding may reduce the thickness of the titanium plate, for example if the cladding is accomplished by cold roll bonding. The final thickness of the titanium plate after it has been cladded with melting depressant foil is typically 0.25 to 1.5 mm. The titanium core 200 is the major part of the heat transfer plate 201′, 201.

The copper foil 225 comprises at least 98% pure copper and the nickel foil 224 comprises at least 98% pure nickel. Remaining percentages of the copper foil 225 and the nickel foil 224 may be other alloy metals or impurities. In case a zirconium foil is used, this foil would comprise at least 98% pure zirconium.

Each of the copper foil 225 and the nickel foil 224 has a thickness that is less than 20%, or less than 10%, or less than 4% of a thickness of the titanium plate 200, or the plate 201, which includes the melting depressant foils. A zirconium foil would also have a thickness that is less than 20%, or less than 10%, or less than 4% of a thickness of the titanium plate 200 or the plate 201. Thus, each of the copper foil 225, the nickel foil 224 and, if it is used, the zirconium foil, has a thickness that is less than 20%, or less than 10%, or less than 4% of the thickness of the heat transfer plate 201, i.e. the thickness of the titanium plate 200 plus the thickness of all melting depressant foils that are arranged on the titanium plate 200. For example, the titanium plate 200 may have a thickness of 1 mm, the nickel foil 224 may have a thickness of 0.015 mm and the copper foil 225 may have a thickness of 0.015 mm.

Even though it is not necessary, a second melting depressant foil 209 is arranged on a second side of the titanium plate 200. The second melting depressant foil 209 comprises a nickel foil 221 and a copper foil 222. Instead of the copper foil 225 a zirconium foil may be used. The nickel foil 221 is arranged closest to the titanium plate 200. The foils 221, 222 of the second melting depressant foil 209 are identical to the foils of the first melting depressant foil 208. As will be described below, other configurations of melting depressant foils may be used.

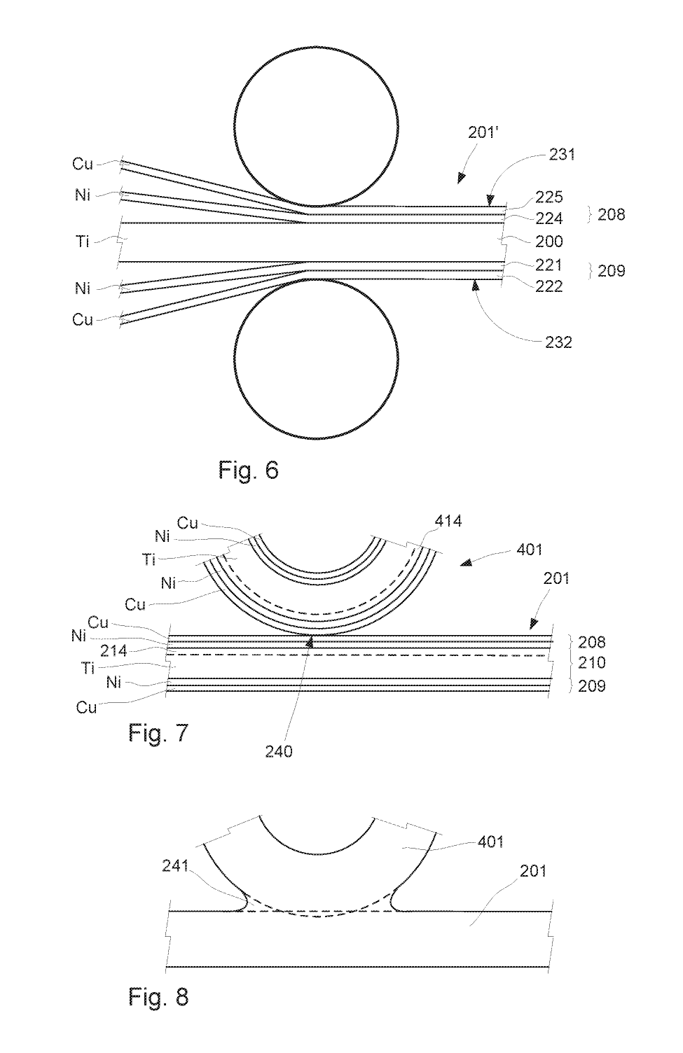

With reference to FIG. 6, the heat transfer plate 201′, as it appears before it is pressed with a pattern, is obtained by cladding the titanium plate 200 with the first melting depressant foil 208 and the second melting depressant foil 209, on a respective side 231, 232 of the plate 201′, i.e. on a respective side of the titanium core 200. The cladding may be accomplished by rolling, for example by conventional cold roll bonding techniques. The melting depressant foils 208, 209 are then effectively bonded together with the titanium plate 200. Of course, any other suitable technique may be used for bonding the melting depressant foils to the titanium plate 201′.

During cold roll bonding a high pressure is applied on the layers, i.e. on the copper foils, the nickel foils and the on titanium plate 200. This may in an undesirable manner change the ductile properties of in particular the titanium in the plate 201′. To regain or at least improve the ductile properties the plate 201′ it may be heat treated after the cold rolling. This is done at a temperature of about 650 to 850° C., for a predetermined time and in accordance with the principles of conventional heat treating of titanium.

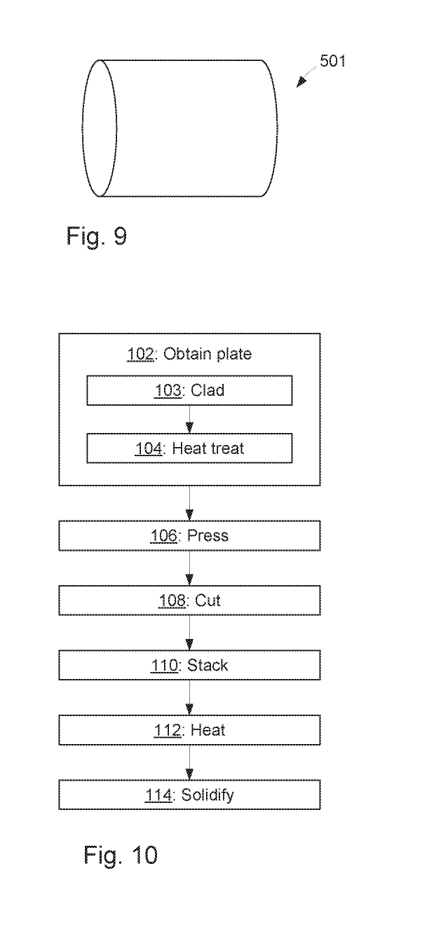

The plate 201′ with the titanium core 200 and melting depressant foils 208, 209 may be formed as a continuous strip with a desired width. The strip may be rolled into a coil 501, as illustrated by FIG. 9. The heat treatment may be performed before forming the coil or after the coil has been formed.

With reference to FIGS. 7 and 8, when a plate 201 in the stack 301 is heated to a temperature just below the melting temperate of titanium, then the melting depressant foils 208, 209 act as melting depressants for the titanium 200 in the plate 201 and cases the surface layers 214 of the plates 201 to melt. The temperature is above 850° C. and below the melting point of titanium, or below 1050° C. All surface layers of all titanium plates 200 that are in contact with the melting depressant foils 208, 209 melt, and how much of the surface layer 214 that melt is determined by the thickness of the copper and nickel foils of the melting depressant foils 208, 209. When two similar plates 201,401 of titanium with melting depressant foils are arranged in contact with each other, the melted titanium in the respective melted surface layer 214, 414 flows, by way of capillary forces, towards the contact points 240 between the plates 201, 401. After this the melted titanium is allowed to cool down and thereby solidify, with the result that joints 241 are formed at the contact points 240 between adjacent plates 201, 401 at the point to where the melted titanium flowed. All titanium in the joint then comes from titanium that was part of surface layer 214 of the plate 201. Thus, a self-brazing titanium plate has been accomplished. If titanium is added in some other way, for example by including some in the melting depressant foils, then not all titanium comes from the heat transfer plates in the stack 301. However, typically at least 80% or at least 90% of the titanium in the joints 241 is, before the joining, part of a heat transfer plate 201 in the stack 301 of titanium heat transfer plates.

With reference to FIG. 10, a method of producing a titanium plate heat exchanger like the one in FIG. 1 comprises a number of steps. In a first step a titanium plate 201′ is obtained 102. The obtained titanium plate 201′ may come e.g. in form of the coil 501, and has been, as described above, clad 103 with the melting depressant foil 208 on at least one side 231 of the plate 201′. Even though it is not necessary, the plate has typically been heat treated 104 after the cladding 103, as described above.

After that a conventional operation of pressing 106 the pattern 234 in the plate 201 is performed, which forms the tops 236 and bottoms 237 in the plate. The pressing 106 typically comprises pressing the titanium plate 201 with a press depth of at least 1.5 mm, as seen from the highest top to the lowest bottom in the plate, and the tops 236 and bottoms 237 of the pressed plate 201 is thus, on the side of the titanium plate 201 that is clad with the melting depressant foil 208, 209, covered with the melting depressant foil 208. The plate has after this operation become a pressed heat transfer plate 201, and is referred to as a titanium plate, even though it is not only made of titanium (its melting depressant foil is made of another material).

After the step of pressing 106, the plate 201 is cut 108 to a predetermined shape. This includes cutting the plate 201 along its peripheral edge 233 and cutting the through holes 210-213. The cutting operation may in part or in full be performed before pressing 106 the pattern in the plate heat transfer plate 201. Typically, the coil 501 has a size that allows several heat transfer plates to be cut from the coil 501 and thereafter pressed.

Next a number of similar heat transfer plate 201 is stacked 110 on top of each other, such that the stack 301 of titanium plates 201, 401 is formed. During the stacking the plates come in contact with each other, and contact points 240 are thus formed between adjacent titanium plates 201, 401 in the stack 301.

The operations for pressing 106, cutting 108 and stacking 110 plates are performed according to known techniques. The end plates 6, 7 are similar to the plate 201, with the difference that the titanium core is thicker. The connectors 8 may be omitted depending on the intended use of the plate heat exchanger 1. If the connectors 8 are used they may be made of the same titanium as the plate 201, and may be attached to the stack 301 by using conventional titanium brazing techniques.

Next the stack 301 of titanium plates is heated 112 to a temperature above 850° C. and below the melting point of titanium. As explained, the melting depressant foil 208 then acts as a melting depressant for the titanium in the titanium plates 201 and cause surface layers 214 of the titanium plates 201 to melt. The melted titanium then flows to the contact points 240 between adjacent titanium plates 201, 401. Thereafter the melted titanium is allowed 114 to solidify (cool) with the result that joints 241 are formed at the contact points 240 between adjacent titanium plates 201, 401. The heat transfer plates in the stack 301 are then effectively joined. Another advantage with producing a plate heat exchanger according to this method is that the titanium in the plate is protected, by the melting depressant foils, from chemical reaction with the surrounding atmosphere, in particular when both sides of the titanium is cladded with melting depressant foils.

Times and temperatures for performing the step of heating 112 and cooling 114 may depend on the configuration and the thickness the melting depressant foils. For a plate where the titanium core is 0.45 mm thick and where each melting depressant foil comprises a copper foil with a thickness of 3 μm, a nickel foil with a thickness of 6 μm and a copper foil with a thickness of 3 μm, then the heating 112 and cooling 114 may be performed according to the example cycle below. For this example the nickel (Ni) foil is located between two copper (Cu) foils, and both sides of the titanium (Ti) are clad with the melting depressant foil. Thus, the example is a so called Cu—Ni—Cu—Ti—Cu—Ni—Cu plate configuration. A conventional brazing oven was used when performing the cycle. Other plate configurations, i.e. combinations of Cu, Ni and/or Zr foils that form the melting depressant foil may be used, as described further on and as previously illustrated (FIG. 5 shows a Cu—Ni—Ti—Ni—Cu plate configuration).

The cycle included heating the stack 301, which had 20 plates, from 22 C° to 550 C° during a period of 30 minutes, holding the temperature at 550 C° for a period of 20 minutes, flushing the stack with argon gas for 10 minutes at 550 C° and thereafter evacuating the argon gas to perform the following steps in vacuum. The following steps include increasing the temperature to 900 C° during a period of 20 minutes, holding the temperature at 900 C° for 30 minutes, increasing the temperature to 1025 C° during a period of 5 minutes, holding the temperature at 1025 C° during a period of 30 minutes, reducing the temperature to 900 C° for during a period of 30 minutes, and holding the temperature at 900 C° for 30 minutes. Thereafter the vacuum is released, the oven is shut off and the stack 301 is allowed to cool down inside the oven until it reaches a temperature of 22 C° (the surrounding temperature).

The obtained stack 301 was perfectly sealed at all contact points between the heat transfer plates in the stack 301.

Other cycles for brazing the stack 301 of titanium plates may be used, and it is estimated that conventional titanium brazing cycles be used.

The described example was performed for a Cu—Ni—Cu—Ti—Cu—Ni—Cu plate configuration. Other configurations may be used, including the following which indicate the order of the foils, where “Cu” represents a copper foil, “Ni” represents a nickel foil, “Zr” represents a zirconium foil and “Ti” represents a titanium plate: Ni—Cu—Ti—Cu—Ni, Cu—Ni—Ti—Ni—Cu, Zr—Ni—Ti—Ni—Zr, Zr—Ni—Cu—Ti—Cu—Ni—Zr, Ni—Ti—Ni, Cu—Ti—Cu, Ni—Ti—Cu, Cu—Ti—Ni. Other combinations are possible, for example may Zr replace Cu for one or more of the embodiments, partly or in full. More layers of Ni, Cu and Zr may also be used, and their order may be changed.

The described plate heat exchanger is only one example of a type of plate heat exchanger that the production method may be used for. Any other suitable plate heat exchanger type may be produced according to the method, including types that have other type of plate patterns, other number of port openings in the plates etc. The production method may also be used for joining other parts made of titanium, where a joint if formed between the parts by titanium that has been melted by the use of melting depressant foils.

From the description above follows that, although various embodiments of the invention have been described and shown, the invention is not restricted thereto, but may also be embodied in other ways within the scope of the subject-matter defined in the following claims.

1. A method of producing a plate heat exchanger, comprising
obtaining a titanium plate that has been cladded with a melting depressant foil on at least one side of the plate,
pressing a pattern in the titanium plate, such that tops and bottoms are formed in the plate,
stacking the titanium plate on a number of similar titanium plates, so as to form a stack of, clad, heat treated and pressed, titanium plates, where contact points are formed between adjacent titanium plates in the stack of titanium plates,
heating the stack of titanium plates to a temperature above 850° C. and below the melting point of titanium, such that the melting depressant foil acts as a melting depressant for the titanium in the titanium plates and causes surface layers of the titanium plates to melt, the melted titanium thereby flowing to the contact points between adjacent titanium plates,
allowing the melted titanium to solidify and form joints at the contact points between adjacent titanium plates.

2. A method according to claim 1, wherein the titanium plate has, before pressing a pattern in the titanium plate, a thickness of 0.25 to 1.5 mm.

3. A method according to claim 1, wherein the melting depressant foil comprises
a nickel foil, and
any of a copper foil and a zirconium foil.

4. A method according to claim 1, wherein the melting depressant foil is cladded on a first side of the plate and a second melting depressant foil is cladded on a second side of the plate, each of the first and second melting depressant foils comprising, respectively
a first copper foil
a nickel foil, and
a second copper foil,
the nickel foil being located between the first and second copper foils.

5. A method according to claim 3, wherein the nickel foil has, before pressing a pattern in the titanium plate, a thickness that is less than 20% of a thickness of the titanium plate.

6. A method according to claim 3, wherein the copper foil has, before pressing a pattern in the titanium plate, a thickness that is less than 20% of a thickness of the titanium plate.

7. A method according to claim 3, wherein the zirconium foil has, before pressing a pattern in the titanium plate, a thickness that is less than 20% of a thickness of the titanium plate.

8. A method according to claim 1, wherein the titanium plate has been cladded with melting depressant foil on each of two sides of the titanium plate.

9. A method according to claim 3, wherein the titanium plate has been cladded with the copper foils and the nickel foils by rolling.

10. A method according to claim 1, wherein the cladded titanium plate has been heat treated at a temperature of 650 to 850° C.

11. A method according to claim 1, wherein the pressing comprises pressing the titanium plate with a press depth of at least 1.5 mm.

12. A method according to claim 1, wherein the tops and bottoms of the pressed titanium plate are, on the side of the titanium plate that is clad with the melting depressant foil, covered with the melting depressant foil.

13. A method according to claim 1, comprising, after the cladding and the heat treating, cutting the titanium plate to a predetermined shape.

14. A method according to claim 1, wherein the heating comprises heating to a heating temperature at 850 to 1050° C.

15. A method according to claim 1, wherein the titanium plate comprises titanium type grade 1 or titanium type grade 2, and the melting depressant foil comprises any of
a copper foil that comprises at least 98% pure copper,
a nickel foil that comprises at least 98% pure nickel, and
a zirconium foil that comprises at least 98% pure zirconium.

16. A method according to claim 1, wherein at least 90% of the titanium in the joints was, before the heating, part of any one of the heat transfer plates in the stack of titanium heat transfer plates.

17. A heat exchanger that comprises a number of titanium heat transfer plates that are obtained from a titanium plate that has been cladded with a melting depressant foil on at least one side of the plate, and heat treated after the cladding, a pattern being pressed in the titanium plate, such that tops and bottoms are formed in the plate, wherein the titanium plate is stacked on a number of titanium plates, so as to form a stack of, clad, heat treated and pressed, titanium plates, where contact points are formed between adjacent titanium plates in the stack of titanium plates, and wherein the stack of titanium plates has been heated to a temperature above 850° C. and below the melting point of titanium, such that the melting depressant foil has acted as a melting depressant for the titanium in the titanium plates and caused surface layers of the titanium plates to melt and flow to the contact points between adjacent titanium plates and form joints at the contact points between adjacent titanium plates when the melted titanium has been allowed to solidify.

18. A metal coil suitable for producing a plate heat exchanger according to the method of claim 1, the metal coil comprising a titanium plate that is cladded with a melting depressant foil on at least one side of the titanium plate.
